(19) United States
(12) Patent Application Publication
(10) Pub. No.: US 2006/0094457 A1
(43) Pub. Date: May 4, 2006

(54) Wireless communication terminal with power delay function

(76) Inventor: Ki-Tak Song, Incheon (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/262,462

(22) Filed: Oct. 28, 2005

(30) Foreign Application Priority Data
Oct. 29, 2004 (KR) 2004-0087394

(51) Int. Cl. H04B 7/00

(52) U.S. Cl. 455/522

(57) ABSTRACT

A wireless communication terminal with a power delay function is provided to prevent a power-on of the terminal by an external force rather than by a user's intention by delaying a time taken to apply a power using a power delay circuit (e.g., capacitor having a large capacitance value). The invention comprising a power transfer unit for providing a switch-on signal to a controller in response to a power-on switching signal from the outside and dividing a voltage of a driving power transferred from an external power supply, a power delay unit for delaying the driving power from the power transfer unit, a power loop hold unit for holding a power loop based on a power hold signal from the controller and the driving signal from the power delay unit, a power apply unit for converting the power from the power supply into a constant voltage in accordance with the driving power from the power loop hold unit and applying the converted constant voltage to the controller, and the controller driven in response to the constant voltage from the power apply unit for providing the power hold signal to the power loop hold unit in response to the switch-on signal from the power transfer unit.

### FIELD OF THE INVENTION

The present invention relates to a wireless communication terminal with a power delay function; and more particularly, to a wireless communication terminal with a power delay function of preventing a power-on of the terminal by an external force rather than by a user's intention by delaying a time taken to apply a power using a power delay circuit (e.g., capacitor having a large capacitance value).

### DESCRIPTION OF RELATED ART

A wireless communication terminal refers to a terminal capable of wireless communication while each individual carries such a terminal as PCS (personal communication services) terminal, PDA (personal digital assistant) terminal, smart phone, IMT-2000 (International Mobile Telecommunication-2000) terminal, wireless LAN terminal, or the like.

FIG. 1 is a configuration diagram showing an embodiment of a conventional wireless communication terminal.

As shown in FIG. 1, the conventional wireless communication terminal comprises a power supply (battery) 101 for supplying a power to the interior of the terminal, a switch 102 for transferring or blocking the driving power from the power supply 101 in response to a power-on/off switching signal from the outside, two resistors 103 and 104 for dividing a voltage of the driving power from the switch 102, a capacitor 105 connected in parallel with the resistor 104, a first diode 106 for transferring the driving power from the two resistors 103 and 104 to a first transistor 107 and preventing a reverse current (power hold signal PS_HOLD) from a mobile station modem (MSM) 109, and the first transistor 107 turned on in accordance with the power from the first diode 106 for outputting the driving power. In addition, the conventional wireless communication terminal further comprises a low voltage drop regulator 108 for converting the power from the power supply 101 into a constant voltage in response to the driving power from the first transistor 107 and applying the converted constant voltage to the MSM 109, the MSM 109 driven by the constant voltage from the low voltage drop regulator 108 for providing the power hold signal PS_HOLD to the first diode 110 in response to a power-on signal from a second transistor 111, a second diode 110 for transferring the power hold signal PS_HOLD from the MSM 109 to the first transistor 107 and blocking a reverse current from the first diode 106, and the second transistor 111 driven by receiving a base voltage in response to a switch-on signal and transferring the power-on signal to the MSM 109.

Typically, under a power-off state of the wireless communication terminal, a time taken until a main chip set (MSM) is driven after depressing a power key is about 200 ms with very fast speed. That is, the power is turned on by simply depressing the power key for a little while, whereas it is turned off by depressing for a relatively long time under the power-on state.

Meanwhile, such wireless communication terminals are classified into folder, bar, and slide types of terminals according to the shape thereof. A variety of keys including a power key are arranged within the folder in the general folder type wireless communication terminal, while the power key is exposed on the outside in the bar or slide type terminal.

Consequently, the bar or slide type wireless communication terminal where the power key exhibits on the outside may be turned on unintentionally by depressing the power key by an external force when it is within a pocket or bag after a power-off thereof.

### SUMMARY OF THE INVENTION

It is, therefore, a primary object of the present invention to provide a wireless communication terminal with a power delay function that prevents a power-on of the terminal by an external force rather than by a user's intention by delaying a time taken to apply a power using a power delay circuit (e.g., capacitor having a large capacitance value).

In accordance with the present invention, there is provided a wireless communication terminal, comprising: a power transfer unit for providing a switch-on signal to a controller in response to a power-on switching signal from the outside, and dividing and outputting a voltage of a driving power transferred from an external power supply; a power delay unit for delaying the driving power from the power transfer unit; a power loop hold unit for holding a power loop based on a power hold signal from the controller and the driving signal from the power delay unit; a power apply unit for converting the power from the power supply into a constant voltage in accordance with the driving power from the power loop hold unit and applying the converted constant voltage to the controller; and the controller driven in response to the constant voltage from the power apply unit for providing the power hold signal to the power loop hold unit in response to the switch-on signal from the power transfer unit.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIG. 1 is a configuration diagram showing an embodiment of a conventional wireless communication terminal;

FIGS. 2A to 2C are diagrams showing an embodiment of a general voltage division law;

FIG. 3 is an exemplary configuration diagram showing an embodiment of a wireless communication terminal with a power delay function in accordance with the present invention; and

FIGS. 4A and 4B are exemplary views showing characteristics that vary depending on a location of the first transistor in FIG. 3.

### DETAILED DESCRIPTION OF THE INVENTION

The above-mentioned objectives, features, and advantages will be more apparent by the following detailed description in association with the accompanying drawings; and, according to this, the technical spirit of the invention will readily be conceived by those skilled in the art to which the invention belongs. Further, in the following description, well-known arts will be not described in detail if they would obscure the gist of the invention in unnecessary detail. Hereinafter, a preferred embodiment of the present invention will be described in detail with reference to the accompanying drawings.

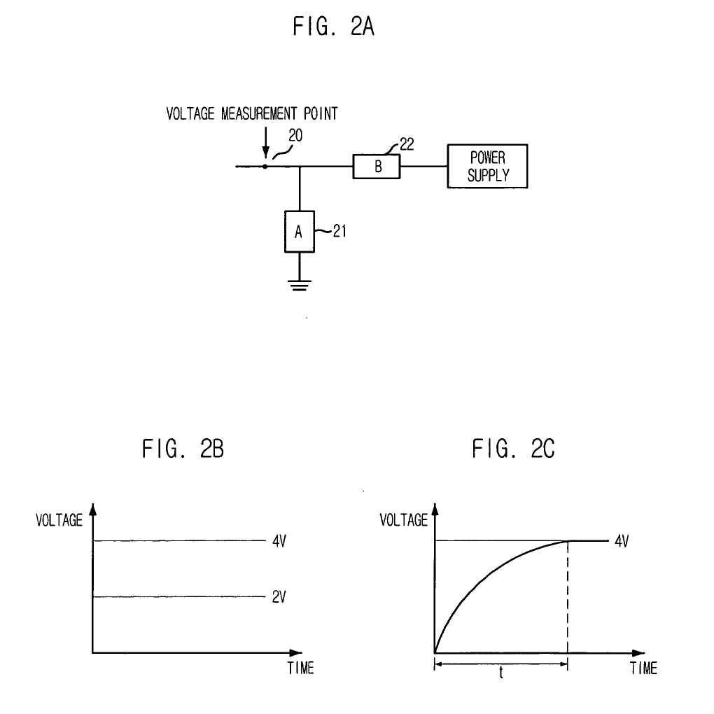

Firstly, a fundamental rule to understand the present invention will be described with reference to FIG. 2.

FIGS. 2A to 2C are diagrams showing an embodiment of a general voltage division rule.

As illustrated in FIG. 2A, a voltage at a voltage measurement point 20 is varied on the basis of A and B devices 21 and 22 used in the voltage division circuit.

For example, if the A and B devices 21 and 22 are resistors having the same resistance value, the voltage at the point 20 is 2 V when a voltage from a power supply is 4 V, as indicated in FIG. 2B.

However, if the A device 21 is a capacitor with large capacitance value and the B device 22 is a resistor, it can be seen from FIG. 2C that the voltage at the point 20 becomes 4 V after passing through a sufficient time t (indicating a time taken until the capacitor is charged) when the voltage from the power supply is 4 V.

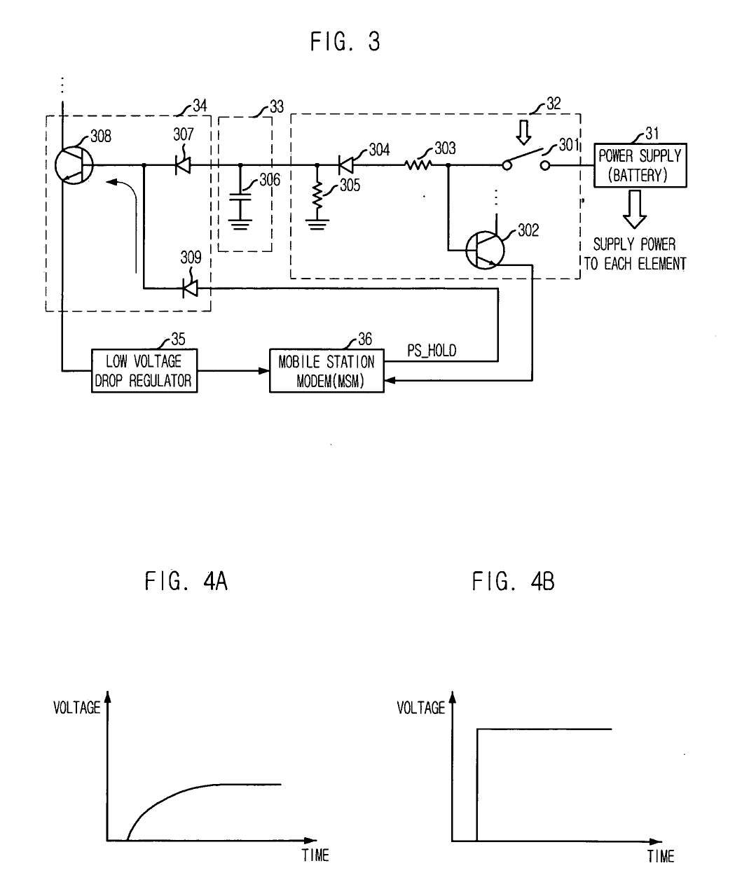

FIG. 3 is an exemplary configuration diagram appearing an embodiment of a wireless communication terminal with a power delay function in accordance with the present invention.

As illustrated in FIG. 3, the wireless communication terminal with a power delay function of the invention comprises a power supply (battery) 31 for supplying a power to each element of the terminal, a power transfer unit 32 for transferring a switch-on signal to a mobile station modem (MSM) 36 in response to a power-on switching signal from the outside, and dividing and outputting a voltage of the driving power from the power supply 31, a power delay unit 33 for delaying the driving power from the power transfer unit 32, a power loop hold unit 34 for transferring the driving power from the power delay unit 33 to a low voltage drop regulator 35 and holding a power loop in response to a power hold signal PS_HOLD from the MSM 36, the low voltage drop regulator 35 for converting the power from the power supply 31 into a constant voltage in response to the driving power from the power loop hold unit 34 and applying the converted constant voltage to the MSM 36, and the MSM 36 driven by the constant voltage from the low voltage drop regulator 35 for providing the power hold signal PS_HOLD to the power loop hold unit 34 in response to the switch-on signal from the power transfer unit 32.

More specifically, the power transfer unit 32 includes a switch 301 for transferring, in response to the power-on switching signal from the outside, the switch-on signal to a first transistor 302 and also the driving power from the power supply 31 to a first resistor 303, a first and a second resistors 303 and 305 for dividing a voltage of the driving power from the switch 301, the first transistor 302 for transferring the switch-on signal from the switch 301 to the MSM 36, and a first diode 304 arranged between the first and the second resistors 303 and 305 for transferring the divided driving power from the two resistors 303 and 305 to the power delay unit 33 and blocking a reverse current from the power delay unit 33.

The power delay unit 33 includes a capacitor 306 having a large capacitance value for delaying the power by charging with the driving power from the power transfer unit 32.

The theoretical value or simulation value of the capacitor 306 having the large capacitance value varies depending on its neighboring two resistors 303 and 305 and the voltage from the power supply 31. In the general wireless communication terminal, it is usually adopted that the first resistor 303 is 150 kΩ, the second resistor 305 is 91 kΩ, and the apply voltage from the power supply 31 is about 4 V. From the computation or simulation adopting the above elements and apply voltage, approximately more than 3 sec is consumed from the power switch-on to the booting when the capacitor 306 having the large capacitance value is assigned about 33 uF.

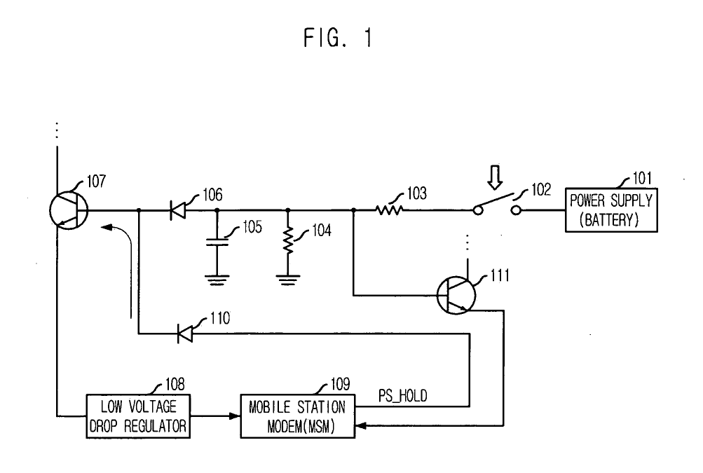

In contrast, since the capacitor 105 of FIG. 1 ranges from 1 pF to 1 uF, it does not give any specific role within the circuit, wherein about 200 ms is taken from the power switch-on to the booting in the existing wireless communication terminal.

Namely, if the capacitor 306 having the large capacitance value used in the invention has about dozens of uF, the power apply time can sufficiently be delayed.

Meanwhile, the power loop hold unit 34 includes a second diode 307 for allowing a current from the power delay unit 33 passed through to a second transistor 308 and blocking a reverse current from a third diode 309, the second transistor 308 turned on according to the power from the second diode 307 and the third diode 309 for maintaining the power loop, and the third diode 309 for permitting a current (power hold signal PS_HOLD) from the MSM 36 to be transferred to the second transistor 308 and blocking a reverse current from the second diode 307.

In other words, the power loop is held through the second transistor 308, the low voltage drop regulator 35, the MSM 36, and the third diode 309. According to this configuration, the present invention can prevent the power from turning on due to an unintentional instantaneous depress of the power key, by delaying the power apply so that the power loop is started if the switch 301 is depressed during a charge is charged in the capacitor.

FIGS. 4A and 4B are exemplary views showing characteristics that varies depending on a location of the first transistor in FIG. 3.

First of all, it is designed that the switch 301 is used as a close key (or clear key) for closing all operations after the booting of the terminal is completely made. Thus, a close signal for closing all the operations can rapidly be transferred to the MSM 36 only when the operation speed of the first transistor 302 is fast.

However, if a base voltage of the first transistor 302 is provided from a node between the first and the second resistors 303 and 305, as in the prior art of FIG. 1, the operation speed thereof is inevitably slow since a time taken to rise up to a predefined threshold voltage is long, as illustrated in FIG. 4A.

Accordingly, in a preferred embodiment of the invention, it is structured that the base voltage of the first transistor 302 is from an output node of the switch 301 to obtain a more quick operation speed, as depicted in FIG. 4B, thereby enabling a close signal for all the operations to be rapidly transferred to the MSM 36.

As described above, the present invention can prevent a power-on of the terminal by an external force rather than by a user's intention by delaying a time taken to apply a power using a power delay circuit (e.g., capacitor having a large capacitance value).

The present application contains subject matter related to Korean patent application No. 2004-0087394, filed with the Korean Intellectual Property Office on Oct. 29, 2004, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A wireless communication terminal, comprising:
a power transfer unit for providing a switch-on signal to a controller in response to a power-on switching signal from the outside, and dividing and outputting a voltage of a driving power transferred from an external power supply;
a power delay unit for delaying the driving power from the power transfer unit;
a power loop hold unit for holding a power loop based on a power hold signal from the controller and the driving signal from the power delay unit;
a power apply unit for converting the power from the power supply into a constant voltage in accordance with the driving power from the power loop hold unit and applying the converted constant voltage to the controller; and
the controller driven in response to the constant voltage from the power apply unit for providing the power hold signal to the power loop hold unit in response to the switch-on signal from the power transfer unit.

2. The wireless communication terminal as recited in claim 1, wherein the power delay unit is a capacitor having a capacitance value of dozens of uF.

3. The wireless communication terminal as recited in claim 1, wherein the power transfer unit comprises:
a switching unit for outputting the switch-on signal in response to the power-on switching signal from the outside and outputting the driving power transferred from the power supply;
a voltage distributor for dividing the voltage of the driving power transferred from the switching distributor; and
a signal transfer distributor for transferring the switch-on signal from the switching distributor to the controller.

4. The wireless communication terminal as recited in claim 3, wherein the power divider comprises:
a first resistor connected between an output node of the switching unit and a reverse current protection unit;
the reverse current protection unit arranged between the first resistor and the power delay unit for transferring a current in a forward direction; and
a second resistor coupled between an output node of the reverse current protection unit and the earth.

5. The wireless communication terminal as recited in claim 4, wherein the reverse current protection unit is a diode.

6. The wireless communication terminal as recited in claim 3, wherein the signal transfer unit is implemented by a transistor that receives a base voltage from an output node of the switching unit.
